(19) United States
(12) Patent Application Publication
(10) Pub. No.: US 2014/0055603 A1
(43) Pub. Date: Feb. 27, 2014

(54) AUTOMATIC OPTICAL INSPECTION DEVICE

(71) Applicant: Yung-yu Lin, Guangdong (CN)

(72) Inventor: Yung-yu Lin, Guangdong (CN)

(73) Assignee: SHENZHEN CHINA STAR OPTOELECTRONICS TECHNOLOGY CO., LTD., Guangdong (CN)

(21) Appl. No.: 13/695,763

(22) PCT Filed: Sep. 21, 2012
(86) PCT No.: PCT/CN12/81734

§ 371 Date: Nov. 1, 2012

(30) Foreign Application Priority Data
Jul. 25, 2012 (CN) 201210259431.0

(51) Int. Cl. G01N 21/95

(52) U.S. Cl. CPC G01N 21/95
USPC 348/126

(57) ABSTRACT

Disclosed is an automatic optical inspection device. The automatic optical inspection device comprises a substrate support platform, a sensor fixed platform, an image sensor, and a backlight source. The automatic optical inspection device of the present invention is capable of inspecting defects in an interior of a substrate for solving the technical problem that the conventional automatic optical inspection device fails to inspect the defects in the interior of the substrate.

### BACKGROUND OF THE INVENTION

1. Field of the Invention

The present invention generally relates to a substrate defect inspection field, and more particularly to an automatic optical inspection device for inspecting defects of a substrate.

2. Description of Prior Art

Automatic optical inspection is a commonly used method for inspecting a substrate material, such as a glass substrate et al., and a semifinished material in a liquid crystal industry. An automatic optical inspection device may be used for inspecting whether an image on a surface of a substrate conforms to rules and whether dot defects exist due to disruptive materials, and accurately determining positions of the dot defects due to the disruptive materials. Generally, a charge-coupled device (CCD) image sensor of the automatic optical inspection device captures a substrate to be inspected for obtaining a gray level image of the substrate to be inspected. Then, it is determined that whether the dot defects exist on the substrate to be inspected by analyzing the gray level image.

FIG. 1 shows a structural diagram of a conventional automatic optical inspection device. The automatic optical inspection device comprises an image sensor 11, a sensor fixed platform 12, a substrate support platform 13, and a substrate transport module (not shown). When the automatic optical inspection device is in use, the substrate transport module drives a substrate 14 to be inspected (e.g. a glass substrate) to move on the substrate support platform 13. Meanwhile, the image sensor 11 captures a surface of the substrate 14 to be inspected. After the captured image is converted to a gray level image, the gray level image is compared with a substrate gray level image which is inputted in advance for determining whether the dot defects exists on the substrate and positions of the dot defects.

However, the automatic optical inspection device only can inspect the dot defects on the surface of the substrate 14 to be inspected. When the dot defects exist in an interior of the substrate 14 to be inspected, the dot defects cannot be inspected and thus the unqualified substrate is transported to a next process.

Consequently, there is a need to provide an automatic optical inspection device for solving the problem in the prior arts.

### SUMMARY OF THE INVENTION

An objective of the present invention is to provide an automatic optical inspection device capable of inspecting defects in an interior of a substrate for solving the technical problem that the conventional automatic optical inspection device fails to inspect the defects in the interior of the substrate.

To solve the above-mentioned problem, a technical scheme provided by the present invention is as the following.

The present invention relates to an automatic optical inspection device. The automatic optical inspection device comprises:

a substrate support platform for supporting a substrate to be inspected;

a sensor fixed platform disposed above the substrate to be inspected;

an image sensor disposed to the sensor fixed platform for capturing the substrate to be inspected; and

a backlight source disposed beneath the substrate to be inspected and corresponding to a position of the image sensor for irradiating an inspection part of the substrate to be inspected;

the substrate support platform having a gap part disposed therein, the backlight source movably disposed in the gap part, the backlight source and the sensor fixed platform moving synchronously;

the gap part further comprising a blower module disposed therein for providing a lift force for the substrate to be inspected, the blower module setting wind pressure according to a weight of the substrate to be inspected, the backlight source disposed above the blower module.

The present invention further relates to an automatic optical inspection device. The automatic optical inspection device comprises:

a substrate support platform for supporting a substrate to be inspected;

a sensor fixed platform disposed above the substrate to be inspected;

an image sensor disposed to the sensor fixed platform for capturing the substrate to be inspected; and

a backlight source disposed beneath the substrate to be inspected and corresponding to a position of the image sensor for irradiating an inspection part of the substrate to be inspected;

the substrate support platform having a gap part disposed therein, the backlight source disposed in the gap part;

the gap part further comprising a transparent glass support plate disposed therein for supporting the substrate to be inspected, the backlight source disposed beneath the transparent glass support plate;

an upper surface of the transparent glass support plate being flush with an upper surface of the substrate support platform;

a light absorbing patch adhered to the upper surface of the transparent glass support plate for preventing light on the upper surface of the transparent glass support plate from being reflected.

In the automatic optical inspection device of the present invention, the backlight source is disposed in the gap part, and the backlight source and the sensor fixed platform move synchronously.

In the automatic optical inspection device of the present invention, the backlight source is fixedly disposed in the whole gap part.

The present invention further relates to an automatic optical inspection device. The automatic optical inspection device comprises:

a substrate support platform for supporting a substrate to be inspected;

a sensor fixed platform disposed above the substrate to be inspected;

an image sensor disposed to the sensor fixed platform for capturing the substrate to be inspected; and

a backlight source disposed beneath the substrate to be inspected and corresponding to a position of the image sensor for irradiating an inspection part of the substrate to be inspected.

In the automatic optical inspection device of the present invention, the substrate support platform has a gap part disposed therein, and the backlight source is disposed in the gap part.

In the automatic optical inspection device of the present invention, the gap part further comprises a blower module disposed therein for providing a lift force for the substrate to be inspected, and the backlight source is disposed above the blower module.

In the automatic optical inspection device of the present invention, the blower module sets wind pressure according to a weight of the substrate to be inspected.

In the automatic optical inspection device of the present invention, the backlight source is movably disposed in the gap part, and the backlight source and the sensor fixed platform move synchronously.

In the automatic optical inspection device of the present invention, the gap part further comprises a transparent glass support plate disposed therein for supporting the substrate to be inspected, and the backlight source is disposed beneath the transparent glass support plate.

In the automatic optical inspection device of the present invention, an upper surface of the transparent glass support plate is flush with an upper surface of the substrate support platform.

In the automatic optical inspection device of the present invention, the backlight source is movably disposed in the gap part, and the backlight source and the sensor fixed platform move synchronously.

In the automatic optical inspection device of the present invention, the backlight source is fixedly disposed in the whole gap part.

In the automatic optical inspection device of the present invention, a light absorbing patch is adhered to the upper surface of the transparent glass support plate for preventing light on the upper surface of the transparent glass support plate from being reflected.

Comparing with the conventional automatic optical inspection device, the automatic optical inspection device of the present invention is capable of inspecting the defects in the interior of the substrate for solving the technical problem that the conventional automatic optical inspection device fails to inspect the defects in the interior of the substrate.

For a better understanding of the aforementioned content of the present invention, preferable embodiments are illustrated in accordance with the attached figures for further explanation:

### BRIEF DESCRIPTION OF THE DRAWINGS

FIG. 1 shows a structural diagram of a conventional automatic optical inspection device;

FIG. 2 shows a side view structural diagram of an automatic optical inspection device according to a first preferable embodiment of the present invention;

FIG. 3 shows a cross-sectional view along a sectional line A-A′ in FIG. 2;

FIG. 4 shows a side view structural diagram of an automatic optical inspection device according to a second preferable embodiment of the present invention;

FIG. 5 shows a cross-sectional view along a sectional line B-B′ in FIG. 4.

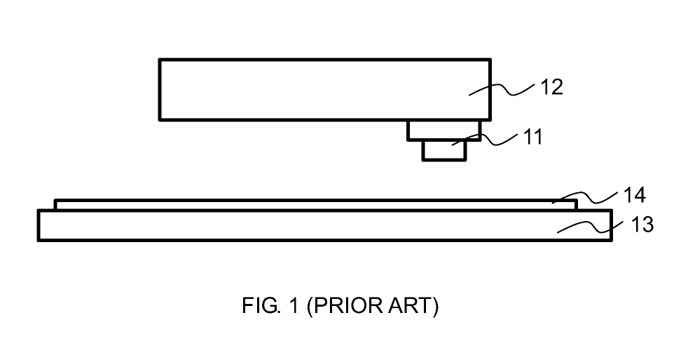

Numerals in the appended figures are described as the following:
21: image sensor
22: sensor fixed platform
23: substrate support platform
231: gap part
232: blower module
333: transparent glass support plate
334: light absorbing patch
24: substrate
25: backlight source

### DETAILED DESCRIPTION OF THE INVENTION

The following descriptions for the respective embodiments are specific embodiments capable of being implemented for illustrations of the present invention with referring to appended figures. For example, the terms of up, down, front, rear, left, right, interior, exterior, side, etcetera are merely directions of referring to appended figures. Therefore, the wordings of directions are employed for explaining and understanding the present invention but not limitations thereto.

In the appended figures, elements having similar structures are represented as the same numeral.

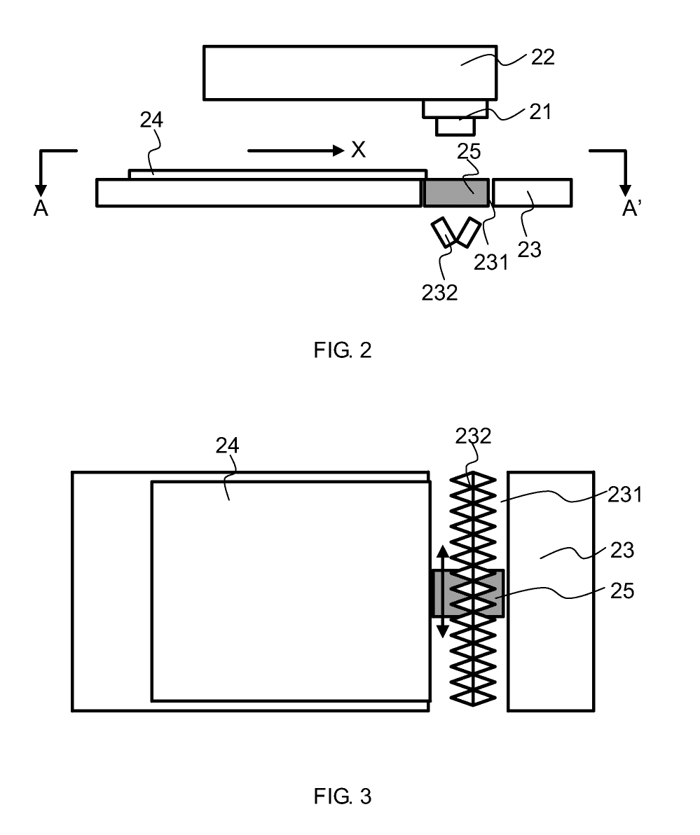

Please refer to FIG. 2 and FIG. 3. FIG. 2 shows a side view structural diagram of an automatic optical inspection device according to a first preferable embodiment of the present invention. FIG. 3 shows a cross-sectional view along a sectional line A-A′ in FIG. 2. The automatic optical inspection device comprises a substrate support platform 23, a sensor fixed platform 22, an image sensor 21, and a backlight source 25. The substrate support platform 23 is utilized for supporting a substrate 24 to be inspected (hereinafter referred to as “inspected substrate”). The sensor fixed platform 22 is disposed above the inspected substrate 24. The image sensor 21 is disposed to the sensor fixed platform 22 for capturing the inspected substrate 24 and acquiring a gray level image of the inspected substrate 24. The backlight source 25 is disposed beneath the inspected substrate 24 and corresponding to a position of the image sensor 21. The image sensor 21 is capable of accurately determining whether the inspected substrate 24 has defects (such as dot defects et al.) in an interior of the inspected substrate 24 by irradiating an inspection part of the inspected substrate 24.

The substrate support platform 23 has a gap part 231 disposed therein. The backlight source 25 is movably disposed in the gap part 231. The backlight source 25 and the sensor fixed platform 22 move synchronously for ensuring a position of the backlight source 25 is corresponding to the position of the image sensor 21. The gap part 231 further comprises a blower module 232 (e.g. an air jet) disposed therein for providing a lift force for the inspected substrate 24. The backlight source 25 is disposed above the blower module 232 and movable above the blower module 232. The blower module 232 is capable of setting wind pressure according to a weight of the inspected substrate 24, such that the inspected substrate 24 may stably pass above the gap part 231. That is, a situation that the inspected substrate 24 collides with an edge of the substrate support platform 23 does not occur when the wind pressure is small, and a situation that the inspected substrate 24 moves unstably does not occur when the wind pressure is large. If the inspected substrate 24 is heavy, the wind pressure of the blower module 232 is set to be high. If the inspected substrate 24 is light, the wind pressure of the blower module 232 is set to be low.

When the automatic optical inspection device of the present embodiment is in use, the wind pressure of the blower module 232 is set according to the weight of the inspected substrate 24. Then, the inspected substrate 24 is placed on the substrate support platform 23. A substrate transport module (not shown) drives the inspected substrate 24 to move in an X-direction in FIG. 2. When the inspected substrate 24 passes the gap part 231 of the substrate support platform 23, the inspected substrate 24 is above the gap part 231 due to effect of the blower module 232. The backlight source 25 and the sensor fixed platform 22 move synchronously (in a direction as shown in FIG. 3). The image sensor 21 of the sensor fixed platform 22 performs a defect inspection on the inspected substrate 24 on the gap part 231. Since the backlight source 25 is disposed beneath the inspected substrate 24 and the image sensor 21 is disposed above the inspected substrate 24, light emitted from the backlight source 25 can pass through an inspection part of the inspected substrate 24. In such a manner, defects on a surface of the inspected substrate 24 affect the gray level image acquired by the image sensor 21, and the defects in the interior of the inspected substrate 24 also affect the gray level image acquired by the image sensor 21. Accordingly, it may be determined that whether the detects exist on the surface or in the interior of the inspected substrate 24 by comparing the gray level image acquired by the image sensor 21 with a substrate gray level image which is inputted in advance. Herein, the inspected substrate 24 may be a pure glass substrate or a substrate which comprises a metal layer (an opaque material and so on) deposited therein and has a specific function.

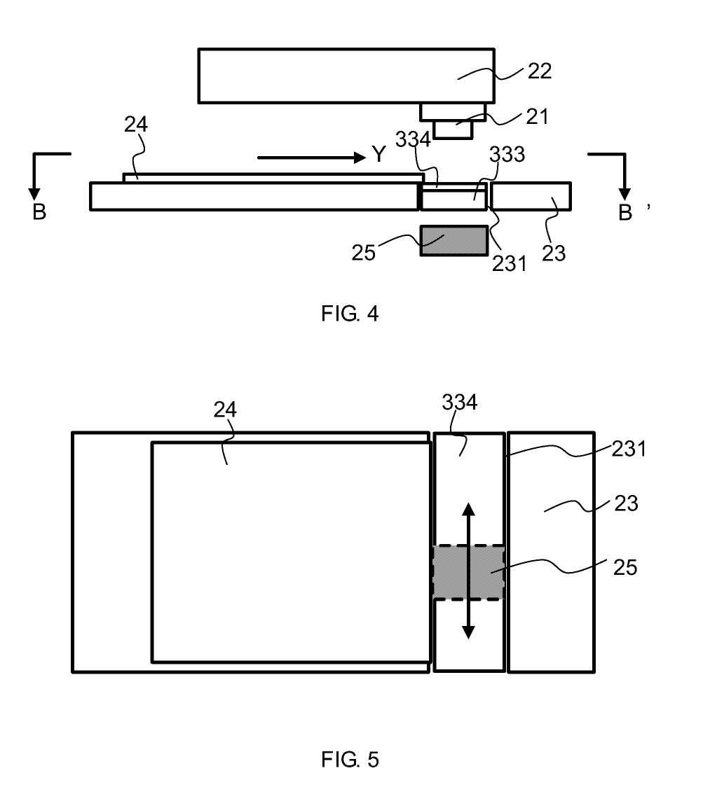

Please refer to FIG. 4 and FIG. 5. FIG. 4 shows a side view structural diagram of an automatic optical inspection device according to a second preferable embodiment of the present invention. FIG. 5 shows a cross-sectional view along a sectional line B-B′ in FIG. 4. A difference between the present embodiment and the first embodiment is that the present embodiment does not comprise the blower module disposed in the gap part 231 of the substrate support platform 23, but a transparent glass support plate 333 is disposed for supporting the inspected substrate 24. The backlight source 25 is disposed beneath the transparent glass support plate 333. An upper surface of the transparent glass support plate 333 is flush with an upper surface of the substrate support platform 23.

The backlight source 25 is movably disposed in the gap part 231. Meanwhile, the backlight source 25 and the sensor fixed platform 22 move synchronously for ensuring performing a defect inspection on an inspection part of the inspected substrate 24.

Certainly, the backlight source 24 may be fixedly disposed in the whole gap part 231. Accordingly, the backlight source 25 is not required moving. The sensor fixed platform 22 drives the image sensor 21 to move above the gap part 231 for performing the defect inspection on the inspection part of the inspected substrate 24.

To improve inspection effect of the image sensor 21, a light absorbing patch 334 is adhered to an upper surface of the transparent glass support plate 333 for preventing reflection (a thickness ratio of the light absorbing patch 334 and the transparent glass support plate 333 is only exemplary and not a practical thickness ratio). The light absorbing patch 334 may avoid that an erroneous judgment occurs when light on the upper surface of the transparent glass support plate 333 reflects and influences the gray level image which is acquired by the image sensor 21. The light absorbing patch 334 absorbs only unidirectional light. The light from the backlight source 25 may pass through the light absorbing patch 334 without being absorbed.

When the automatic optical inspection device of the present embodiment is in use, the inspected substrate 24 is placed on the substrate support platform 23. A substrate transport module (not shown) drives the inspected substrate 24 to move in a Y-direction in FIG. 4. When the inspected substrate 24 passes the transparent glass support plate 333 (i.e. the gap part 231 of the substrate support platform 23), the backlight source 25 and the sensor fixed platform 22 move synchronously (in a direction as shown in FIG. 5, certainly, the backlight source 25 may also be fixedly disposed). The image sensor 21 of the sensor fixed platform 22 performs the defect inspection on the inspected substrate 24 on the transparent glass support plate 333. Since the backlight source 25 is disposed beneath the inspected substrate 24 and the image sensor 21 is disposed above the inspected substrate 24, light emitted from the backlight source 25 can pass through an inspection part of the inspected substrate 24. In such a manner, defects on a surface of the inspected substrate 24 affect a gray level image acquired by the image sensor 21, and detects in an interior of the inspected substrate 24 also affect the gray level image acquired by the image sensor 21. Accordingly, it may be determined that whether detects exist on the surface or in the interior of the inspected substrate 24 by comparing the gray level image acquired by the image sensor 21 with a substrate gray level image which is inputted in advance. Herein, the inspected substrate 24 may be a pure glass substrate or a substrate which comprises a metal layer (an opaque material and so on) deposited therein and has a specific function.

Since the transparent glass support plate 333 is substituted for the blower module for supporting the inspected substrate 24 on the gap part 231 and the upper surface of the transparent glass support plate 333 is flush with the upper surface of the substrate support platform 23, the weight of the inspected substrate 24 does not influence the moving of the inspected substrate 24. Accordingly, the inspected substrate does not collide with an edge of the substrate support platform 23. Compatibility of the automatic optical inspection device of the present invention may be increased for different sizes of the inspected substrate 24.

The automatic optical inspection device of the present invention is capable of inspecting the defects in the interior of the substrate for solving the technical problem that the conventional automatic optical inspection device fails to inspect the defects in the interior of the substrate.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. An automatic optical inspection device, comprising:
a substrate support platform for supporting a substrate to be inspected;
a sensor fixed platform disposed above the substrate to be inspected;
an image sensor disposed to the sensor fixed platform for capturing the substrate to be inspected; and
a backlight source disposed beneath the substrate to be inspected and corresponding to a position of the image sensor for irradiating an inspection part of the substrate to be inspected;
the substrate support platform having a gap part disposed therein, the backlight source movably disposed in the gap part, the backlight source and the sensor fixed platform moving synchronously;
the gap part further comprising a blower module disposed therein for providing a lift force for the substrate to be inspected, the blower module setting wind pressure according to a weight of the substrate to be inspected, the backlight source disposed above the blower module.

2. An automatic optical inspection device, comprising:
a substrate support platform for supporting a substrate to be inspected;
a sensor fixed platform disposed above the substrate to be inspected;
an image sensor disposed to the sensor fixed platform for capturing the substrate to be inspected; and
a backlight source disposed beneath the substrate to be inspected and corresponding to a position of the image sensor for irradiating an inspection part of the substrate to be inspected;
the substrate support platform having a gap part disposed therein, the backlight source disposed in the gap part;
the gap part further comprising a transparent glass support plate disposed therein for supporting the substrate to be inspected, the backlight source disposed beneath the transparent glass support plate;
an upper surface of the transparent glass support plate being flush with an upper surface of the substrate support platform;
a light absorbing patch adhered to the upper surface of the transparent glass support plate for preventing light on the upper surface of the transparent glass support plate from being reflected.

3. The automatic optical inspection device of claim 2, wherein the backlight source is disposed in the gap part, and the backlight source and the sensor fixed platform move synchronously.

4. The automatic optical inspection device of claim 2, wherein the backlight source is fixedly disposed in the whole gap part.

5. An automatic optical inspection device, comprising:
a substrate support platform for supporting a substrate to be inspected;
a sensor fixed platform disposed above the substrate to be inspected;
an image sensor disposed to the sensor fixed platform for capturing the substrate to be inspected; and
a backlight source disposed beneath the substrate to be inspected and corresponding to a position of the image sensor for irradiating an inspection part of the substrate to be inspected.

6. The automatic optical inspection device of claim 5, wherein the substrate support platform has a gap part disposed therein, and the backlight source is disposed in the gap part.

7. The automatic optical inspection device of claim 6, wherein the gap part further comprises a blower module disposed therein for providing a lift force for the substrate to be inspected, and the backlight source is disposed above the blower module.

8. The automatic optical inspection device of claim 7, wherein the blower module sets wind pressure according to a weight of the substrate to be inspected.

9. The automatic optical inspection device of claim 7, wherein the backlight source is movably disposed in the gap part, and the backlight source and the sensor fixed platform move synchronously.

10. The automatic optical inspection device of claim 6, wherein the gap part further comprises a transparent glass support plate disposed therein for supporting the substrate to be inspected, and the backlight source is disposed beneath the transparent glass support plate.

11. The automatic optical inspection device of claim 10, wherein an upper surface of the transparent glass support plate is flush with an upper surface of the substrate support platform.

12. The automatic optical inspection device of claim 10, wherein the backlight source is movably disposed in the gap part, and the backlight source and the sensor fixed platform move synchronously.

13. The automatic optical inspection device of claim 10, wherein the backlight source is fixedly disposed in the whole gap part.

14. The automatic optical inspection device of claim 10, wherein a light absorbing patch is adhered to the upper surface of the transparent glass support plate for preventing light on the upper surface of the transparent glass support plate from being reflected.
